(19) United States
(12) Patent Application Publication
(10) Pub. No.: US 2012/0151076 A1
(43) Pub. Date: Jun. 14, 2012

(54) Method, System and Apparatus for Transmitting Information across Signaling Networks

(75) Inventors: Zhijian Xun, Shenzhen (CN); Qingyong Liang, Shenzhen (CN)

(73) Assignee: ZTE CORPORATION, Shenzhen City, Guangdong Province (CN)

(21) Appl. No.: 13/389,956

(22) PCT Filed: May 24, 2010
(86) PCT No.: PCT/CN2010/073142

§ 371 Date: Feb. 10, 2012

(30) Foreign Application Priority Data
Sep. 3, 2009 (CN) 200910171290.5

(51) Int. Cl. G06F 15/16

(52) U.S. Cl. 709/230

(57) ABSTRACT

The present invention provides a method, system and apparatus for transmitting information across signaling networks. The method includes: when a signaling transfer point belongs to more than one signaling network at the same time, setting a mapping relation between different signaling networks on the signaling transfer point; signaling networks to which the signaling transfer point belongs include a first signaling network and a second signaling network; the signaling transfer point, after receiving a message indicating a destination signaling point code sent by first signaling network and when judging that there is no signaling point where the signaling point code is the destination signaling point code in the first signaling network, converts the message into a message in the second signaling network according to the mapping relation; and when judging that the destination signaling point of the converted message is available in the second signaling network, forwards the message.

### TECHNICAL FIELD

The present invention relates to the field of wireless communication, and in particular, to a method, a system and an apparatus for transmitting information across signaling networks in the case of interconnection between multi-signaling networks.

### BACKGROUND OF THE RELATED ART

The message transfer part 3-user adaptation layer (M3UA) protocol is described in the protocol stack of the signal transport protocol (SIGTRAN) defined by the internet engineering task force (IETF), which is mainly used for the intercommunication between the No. 7 signaling network and the internet protocol (IP) network.

Along with the development of the network convergence and the IP technology, the networking case of the interconnection between IP networks occurs, that is, the M3UA protocol supports the IP signaling transfer point (IPSTP), in other words, the signaling point in the signaling network has the transfer function.

When the networking environment is relatively complex, the M3UA represents the type of signaling network by using the parameter Network Appearance to divide different signaling networks, and this parameter network appearance normally needs to occupy 4 bytes. Different signaling networks are isolated logically and not interconnected. Different signaling networks can have a same signaling point code, and the signaling point code is the address of the signaling point, which is used for identifying the signaling point.

When the network is expanded or upgraded, and when the IPSTP function of the M3UA is used for interconnecting the signaling networks in multiple areas or interconnecting the networks of multiple manufacturers, the network types may be different due to each network being planned individually, which causes that some signaling points between the networks can not communicate.

### SUMMARY OF THE INVENTION

The technical problem to be solved by the present invention is to provide a method, a system and an apparatus for transmitting information across signaling networks, in which the message interaction and the signaling network management are implemented in different signaling networks in the case of keeping the existing signaling configuration.

In order to solve the above problem, the present invention provides a method for transmitting information across networks, comprising: when a signaling transfer point belongs to more than one signaling network at the same time, setting a mapping relation between different signaling networks on the signaling transfer point according to an interaction requirement of said different signaling networks; signaling networks to which the signaling transfer point belongs comprising a first signaling network and a second signaling network; after receiving a message indicating a destination signaling point code sent by the first signaling network, and when judging that there is no signaling point where a signaling point code is the destination signaling point code in the first signaling network, the signaling transfer point converting the message into a message in the second signaling network according to the mapping relation; and when judging that a destination signaling point of the converted message is available in the second signaling network, forwarding the message in the second signaling network.

The above method further has the following characteristics:

the mapping relation comprises a corresponding relation of network types of the first signaling network and the second signaling network; the step of converting the message into the message in the second signaling network according to the mapping relation comprises: converting the destination signaling point code in the first signaling network into the destination signaling point code in the second signaling network according to the mapping relation; and

the step of forwarding the message in the second signaling network comprises: forwarding the message in the second signaling network when there is a signaling point where the signaling point code is the destination signaling point code in the second signaling network and the signaling point is available in the second signaling network.

The above method further has the following characteristics:

the mapping relation comprises the corresponding relation of the network types of the first signaling network and the second signaling network;

the step of converting the message into the message in the second signaling network according to the mapping relation comprises: the signaling transfer point, after receiving a destination state audit message carrying the destination signaling point code sent by the first signaling network and when judging that no adjacent office where the signaling point code is the destination signaling point code is configured in the first signaling network, converting the destination signaling point code in the first signaling network into the destination signaling point code in the second signaling network according to the mapping relation; and

the step of forwarding the message in the second signaling network comprises: forwarding the message in the second signaling network when there is a signaling point where the signaling point code is the destination signaling point code in the second signaling network and a state of the signaling point is office direction available.

The above method further comprises:

the signaling transfer point, when judging that there is a signaling point where the signaling point code is the destination signaling point code in the second signaling network and judging that the state of the signaling point is an office direction unavailable state, returning an office direction unavailable message to the first signaling network; when judging that the state of the signaling point is a congestion state, returning a signaling point congestion message to the first signaling network.

The above method further has the following characteristics:

the mapping relation comprises the corresponding relation of the network types of the first signaling network and the second signaling network; and

the step of converting the message into the message in the second signaling network according to the mapping relation comprises: the signaling transfer point, after receiving the signaling point congestion message carrying the destination signaling point code sent by the first signaling network and when judging that no adjacent office where the signaling point code is the destination signaling point code is configured in the first signaling network, converting the destination signaling point code in the first signaling network into the destination signaling point code in the second signaling network according to the mapping relation.

The above method further has the following characteristics:

the mapping relation comprises the corresponding relation of the network types of the first signaling network and the second signaling network and corresponding relation of the signaling point codes; and the step of converting the message into the message in the second signaling network according to the mapping relation comprises: converting the destination signaling point code in the first signaling network in the message into a second destination signaling point code in the second signaling network according to the mapping relation.

In order to solve the above technical problem, the present invention further provides a system for implementing message interaction across network types, which comprises a signaling transfer point belonging to more than one signaling network at the same time, wherein, the signaling transfer point comprises a mapping relation configuring unit and a message forwarding unit; the mapping relation configuring unit is configured to set a mapping relation between different signaling networks on the signaling transfer point according to an interaction requirement of said different signaling networks; and the message forwarding unit is configured to, after receiving a message indicating a destination signaling point code sent by a first signaling network and when judging that there is no signaling point where a signaling point code is the destination signaling point code in the first signaling network, convert the message into a message in a second signaling network according to the mapping relation, and when judging that the destination signaling point of the converted message is available in the second signaling network, forward the message in the second signaling network.

The above system further has the following characteristics:

the mapping relation stored by the mapping relation configuring unit comprises a corresponding relation of network types of the first signaling network and the second signaling network; and the message forwarding unit is configured to, after receiving a message indicating a destination signaling point code sent by a first signaling network and when judging that there is no signaling point where a signaling point code is the destination signaling point code in the first signaling network, convert the destination signaling point code in the first signaling network into the destination signaling point code in the second signaling network according to the mapping relation, and forward the message in the second signaling network when there is a signaling point where the signaling point code is the destination signaling point code in the second signaling network and the signaling point is available in the second signaling network.

The above system further has the following characteristics:

the mapping relation stored by the mapping relation configuring unit comprises the corresponding relation of the network types of the first signaling network and the second signaling network; and the message forwarding unit is configured to, after receiving a destination state audit message carrying the destination signaling point code sent by the first signaling network and when judging that no adjacent office where the signaling point code is the destination signaling point code is configured in the first signaling network, convert the destination signaling point code in the first signaling network into the destination signaling point code in the second signaling network according to the mapping relation, and forward the message in the second signaling network when there is a signaling point where the signaling point code is the destination signaling point code in the second signaling network and the state of the signaling point is office direction available.

The above system further has the following characteristics:

the message forwarding unit is further configured to: when judging that there is a signaling point where the signaling point code is the destination signaling point code in the second signaling network and judging that the state of the signaling point is an office direction unavailable state, return an office direction unavailable message to the first signaling network; and when judging that the state of the signaling point is a congestion state, return a signaling point congestion message to the first signaling network.

The above system further has the following characteristics:

the mapping relation stored by the mapping relation configuring unit comprises the corresponding relation of the network types of the first signaling network and the second signaling network; and the message forwarding unit is configured to convert the message into the message in the second signaling network according to the mapping relation by the following way: after receiving the signaling point congestion message carrying the destination signaling point code sent by the first signaling network and when judging that no adjacent office where the signaling point code is the destination signaling point code is configured in the first signaling network, converting the destination signaling point code in the first signaling network into the destination signaling point code in the second signaling network according to the mapping relation.

The above system further has the following characteristics:

the mapping relation stored by the mapping relation configuring unit comprises the corresponding relation of the network types of the first signaling network and the second signaling network and corresponding relation of the signaling point codes; and the message forwarding unit is configured to convert the message into the message in the second signaling network according to the mapping relation by the following way: after receiving the message indicating the destination signaling point code sent by the first signaling network and when judging that there is no signaling point where the signaling point code is the destination signaling point code in the first signaling network, converting the destination signaling point code in the first signaling network in the message into a second destination signaling point code in the second signaling network according to the mapping relation.

The above system further has the following characteristics:

the signaling transfer point further comprises a state management unit, wherein, the state management unit is configured to maintain states of signaling transfer points between different singling networks.

The above system further has the following characteristics:

the state management unit is configured to, when receiving the office direction available message, update the state of the signaling transfer point as the office direction available state; when receiving the office direction unavailable message, update the state of the signaling transfer point as the office direction unavailable state; and is configured to, when receiving the signaling point congestion message, update the state of the signaling transfer point as the congestion state.

The present invention further provides a signaling transfer point, wherein, the signaling transfer point belongs to more than one signaling network at the same time, and the signaling transfer point comprises:

a mapping relation configuring unit, configured to set a mapping relation between different signaling networks on the signaling transfer point according to an interaction requirement of different signaling networks; and

a message forwarding unit, configured to, after receiving a message indicating a destination signaling point code sent by a first signaling network and when judging that there is no signaling point where a signaling point code is the destination signaling point code in the first signaling network, convert the message into a message in a second signaling network according to the mapping relation, and when judging that the destination signaling point of the converted message is available in the second signaling network, forward the message in the second signaling network.

The above system further has the following characteristics:

the mapping relation comprises a corresponding relation of network types of the first signaling network and the second signaling network;

the message forwarding unit is configured to convert the message into the message in the second signaling network according to the mapping relation by the following way: converting the destination signaling point code in the first signaling network into the destination signaling point code in the second signaling network according to the mapping relation.

The above system further has the following characteristics:

the mapping relation comprises the corresponding relation of the network types of the first signaling network and the second signaling network and corresponding relation of the signaling point codes;

the message forwarding unit is configured to convert the message into the message in the second signaling network according to the mapping relation by the following way: converting the destination signaling point code in the first signaling network in the message into a second destination signaling point code in the second signaling network according to the mapping relation.

The above system further has the following characteristics:

the message forwarding unit is configured to, after receiving a destination state audit message carrying the destination signaling point code sent by the first signaling network and when judging that no adjacent office where the signaling point code is the destination signaling point code is configured in the first signaling network, convert the destination signaling point code in the first signaling network into the destination signaling point code in the second signaling network according to the mapping relation, and forward the message in the second signaling network when there is a signaling point where the signaling point code is the destination signaling point code in the second signaling network and a state of the signaling point is office direction available.

The above system further has the following characteristics:

the message forwarding unit is further configured to: when judging that there is a signaling point where the signaling point code is the destination signaling point code in the second signaling network and judging that the state of the signaling point is an office direction unavailable state, return an office direction unavailable message to the first signaling network; and when judging that the state of the signaling point is a congestion state, return a signaling point congestion message to the first signaling network.

The signaling transfer point further comprises:

a state management unit, configured to maintain states of the signaling transfer points between different signaling networks.

When a plurality of signaling networks are interconnected and in the case of keeping the existing signaling configuration, the present invention set the mapping relation between different signaling networks on the signaling transfer point, and the message interaction and the signaling network management are implemented in different signaling networks which cannot intercommunicate originally.

### BRIEF DESCRIPTION OF DRAWINGS

FIG. 1 is a composition structure diagram of a signaling transfer point in a system for implementing message interaction across network types according to an embodiment;

FIG. 2 is a flow diagram of method for transmitting information across signaling networks.

### PREFERRED EMBODIMENTS OF THE PRESENT INVENTION

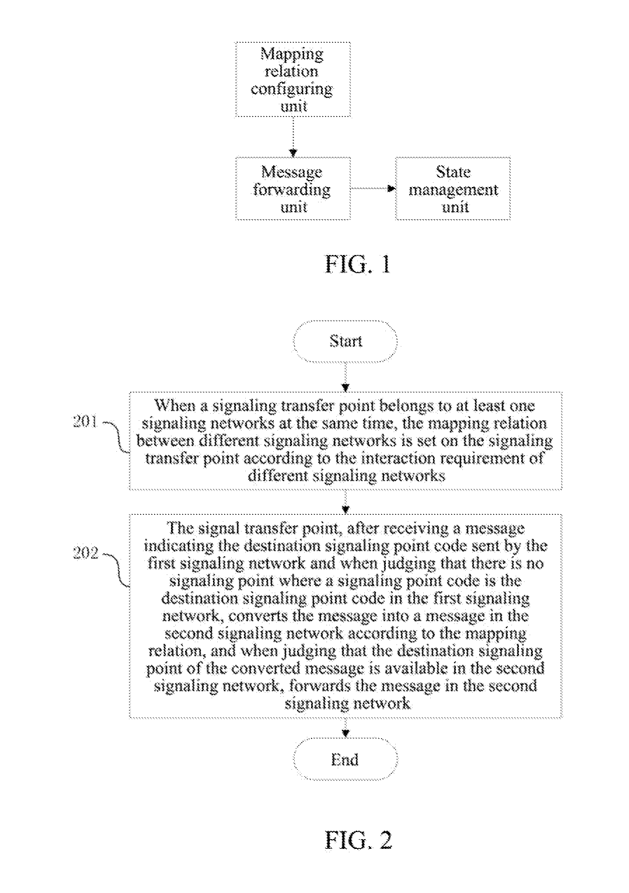

In the embodiment, the system for implementing the message interaction across network types includes a signaling transfer point belonging to more than one signaling networks at the same time. As shown in FIG. 1, the signaling transfer point includes a mapping relation configuring unit, a message forwarding unit and a state management unit;

the mapping relation configuring unit is configured to store the mapping relation set by user between different signaling networks according to the interaction requirement of different signaling networks; when the signaling network to which the signaling transfer point belongs includes a first signaling network and a second signaling network, the mapping relation refers to the corresponding relation of the network types of the first signaling network and the second signaling network, or the corresponding relation of the network types of the first signaling network and the second signaling network and the corresponding relation of signaling point codes.

The message forwarding unit is configured to, after receiving a message indicating a destination signaling point code sent by the first signaling network and when judging that there is no signaling point where the signaling point code is the destination signaling point code in the first signaling network, convert the message into a message in the second signaling network according to the mapping relation, and when judging that the destination signaling point of the converted message is available in the second signaling network, forward the message in the second signaling network.

The way that the message forwarding unit processes the data message, the destination state audit message and the signaling point congestion message sent by the first signaling network is the same with the description in the following methods.

The state management unit is configured to maintain the states of the signaling transfer points between different signaling networks; specifically, when receiving the office direction available message, update the state of the signaling transfer point as the office direction available state; when receiving the office direction unavailable message, update the state of the signaling transfer point as the office direction unavailable state; and is configured to, when receiving the signaling point congestion (SCON) message, update the state of the signaling transfer point as the congestion state.

### Embodiment

as shown in FIG. 2, the method for transmitting information across the signaling networks includes the following steps:

step 201, when a signaling transfer point belongs to more than one signaling networks at the same time, mapping relation between different signaling networks is set on the signaling transfer point according to the interaction requirement of different signaling networks;

the network types of different signaling networks are different, and the network type of the signaling network can be represented by the network appearance. The signaling points in different signaling networks can have the same signaling point code. The mapping relation can include the corresponding relation of the network types of different signaling networks, or also include the corresponding relation of the signaling point codes of different signaling networks.

The mapping relation on the signaling transfer point is set according to the requirement of communication between different signaling networks. When the communication between different signaling networks requires converting the network type, the corresponding relation of network types of different signaling networks is set. When the communication between different signaling networks also requires converting the signaling point code except for converting the network type, the corresponding relation of the signaling point codes is set except that the corresponding relation of the network types is set.

There are many ways for implementing the mapping relation, which includes the simple way of the corresponding table, or the way of the database table, or the mapping algorithm, such as Hash algorithm, etc.

step 202, the signal transfer point, after receiving a message indicating the destination signaling point code sent by the first signaling network (that is, the incoming signaling network, the network from which the message received by the IPSTP is) and when judging that there is no signaling point where the signaling point code is the destination signaling point code in the first signaling network, converts the message into a message in the second signaling network (that is, the outgoing signaling network, the destination network to which the message received by the IPSTP is to be transmitted) according to the mapping relation, and when judging that the destination signaling point of the converted message is available in the second signaling network, forwards the message in the second signaling network.

The above methods are described in detail through the service flow and the management flow hereafter.

### Specific Embodiment 1

the specific embodiment is used for describing the forwarding flow of the data message on the IPSTP. The signaling transfer point belongs to the first signaling network and the second signaling network at the same time, and the mapping relation configured on the IPSTP includes the corresponding relation of network types of the first signaling network and the second signaling network;

step 301, the signaling transfer point receives the data message sent by the incoming network (that is the first signaling network, represented as net1), and the message carries the network appearance of the first signaling network (net1) and the signaling point code of the destination signaling point (spc1);

step 302, the signaling transfer point judges that no corresponding office direction is configured in the first signaling network, that is, there is no signaling point where the signaling point code is spc1 in the first signaling network;

step 303, the signaling transfer point converts the destination signaling point code (spc1) in the first signaling network (net1) in the message into the destination signaling point code (spc1) in the second signaling network (net2) according to the set mapping relation;

step 304, the message routing selection is performed in the second signaling network after the converting is finished; if the routing selection succeeds, that is, there is a signaling point where the signaling point code is spc1 in the second signaling network and the signaling point is available in the second signaling network, forward the message outgoing and finish forwarding the message; or else, proceed to the step 305.

Step 305, if the office direction is available (that is, the converted signaling point code is available in the second signaling network) while the remote user is not available, and the resource signaling point is a direct office, then the opposite end destination user part unavailable (DUPU) message is returned because the remote user is unavailable; the influenced signaling point code is spc1 and the network appearance is net2; if the office direction (net1+spc1) is not available, then the opposite end destination unavailable (DUNA) message is returned, and the influenced signaling point code is spc1 and the network appearance is net2.

### Specific Embodiment 2

the specific embodiment is used for describing the forwarding flow of the destination state audit (DAUD) message on the IPSTP. The signaling transfer point belongs to the first signaling network and the second signaling network at the same time; the mapping relation configured on the IPSTP includes the corresponding relation of network types of the first signaling network and the second signaling network.

Step 401, the signaling transfer point receives the DAUD message where the influenced signaling point code is spc1 in the first signaling network (net1);

step 402, the signaling transfer point judges that there is no adjacent office where the signaling point code is configured as spc1 in the first signaling network;

step 403, the signaling transfer point converts the spc1 in the first signaling network (net1) into the spc1 in the second signaling network (net2) according to the set mapping relation;

step 404, after the converting is finished, if there is a signaling point where the signaling point code is the destination signaling point code in the second signaling network, then the state of the signaling point where the signaling point code is the spc1 in the second signaling network is judged; when the signaling point is in the office direction available state, forward the message in the second signaling network and return the office direction available message to the first signaling network; when the signaling point is in the office direction unavailable state, return the office direction unavailable message to the first signaling network; when the signaling point is in the congestion state, return the signaling point congestion (SCON) message to the first signaling network.

### Specific Embodiment 3

the specific embodiment is used for describing the forwarding flow of the SCON message on the IPSTP. The signaling transfer point belongs to the first signaling network and the second signaling network at the same time, and the mapping relation configured on the IPSTP includes the corresponding relation of network types of the first signaling network and the second signaling network.

Step 501, the signaling transfer point receives the SCON message where the concerned signaling point concerned destination) is the spc1 in the first signaling network (net1);

step 502, the signaling transfer point judges that there is no adjacent office where the point code is configured as the spc1 in the first signaling network;

step 503, the signaling transfer point converts the spc1 in the first signaling network (net1) into the spc1 in the second signaling network (net2) according to the set mapping relation;

step 504, the message routing selection is performed in the second signaling network after the converting is finished, and the message is forwarded to the signaling point where the signaling point code is the spc1.

### Specific Embodiment 4

the specific embodiment is used for describing the forwarding flow of the data message on the IPSTP. The signaling transfer point belongs to the first signaling network and the second signaling network at the same time, and the mapping relation configured on the IPSTP includes the corresponding relation of network types of the first signaling network and the second signaling network and the corresponding relation of the signaling point codes;

step 601, the signaling transfer point receives the data message sent by the incoming network (that is the first signaling network, represented as net1), and the message carries the network type of the first signaling network (net1) and the signaling point code of the destination signaling point (spc1);

step 602, the signaling transfer point does not configure the corresponding office direction in the first signaling network, that is, there is no signaling point where the signaling point code is the spc1 in the first signaling network, and the message cannot be forwarded;

step 603, the signaling transfer point converts the destination signaling point code (spc1) in the first signaling network (net1) in the message into the destination signaling point code (spc2) in the second signaling network (net2) according to the set mapping relation;

step 604, the message routing selection is performed in the second signaling network after the converting is finished; if the routing selection succeeds, forward the message outgoing and finish forwarding the message; or else, return the DUNA or DUPU message to the opposite end.

In the above system and method, through setting the mapping relation between different signaling networks on the signaling transfer point, in the case of keeping the existing signaling configuration, the message interaction and the signaling network management are implemented in different signaling networks which cannot intercommunicate originally.

The above description is only the preferred embodiments of the present invention and is not intended to limit the present invention. For those skilled in the art, the present invention can have various modifications and variations. And all of these modifications, equivalent replacements or the improvements and so on without departing from the spirit and essence of the present invention should be included the protection scope of the present invention.

### INDUSTRIAL APPLICABILITY

When a plurality of signaling networks are interconnected and in the case of keeping the existing signaling configuration, the present invention set the mapping relation between different signaling networks on the signaling transfer point, and the message interaction and the signaling network management ent are implemented in different signaling networks which cannot intercommunicate originally.

What is claimed is:

1. A method for transmitting information across networks, comprising:
when a signaling transfer point belongs to more than one signaling network at the same time, setting a mapping relation between different signaling networks on the signaling transfer point according to an interaction requirement of said different signaling networks;
signaling networks to which the signaling transfer point belongs comprising a first signaling network and a second signaling network, and after receiving a message indicating a destination signaling point code sent by the first signaling network, and when judging that there is no signaling point where a signaling point code is the destination signaling point code in the first signaling network, the signaling transfer point converting the message into a message in the second signaling network according to the mapping relation; and
when judging that a destination signaling point of the converted message is available in the second signaling network, forwarding the message in the second signaling network.

2. The method according to claim 1, wherein,
the mapping relation comprises a corresponding relation of network types of the first signaling network and the second signaling network;
the step of converting the message into the message in the second signaling network according to the mapping relation comprises: converting the destination signaling point code in the first signaling network into the destination signaling point code in the second signaling network according to the mapping relation;
the step of forwarding the message in the second signaling network comprises: forwarding the message in the second signaling network when there is a signaling point where the signaling point code is the destination signaling point code in the second signaling network and the signaling point is available in the second signaling network.

3. The method according to claim 1, wherein,
the mapping relation comprises a corresponding relation of network types of the first signaling network and the second signaling network;
the step of converting the message into the message in the second signaling network according to the mapping relation comprises: the signaling transfer point, after receiving destination state audit message carrying the destination signaling point code sent by the first signaling network and when judging that no adjacent office where the signaling point code is the destination signaling point code is configured in the first signaling network, converting the destination signaling point code in the first signaling network into the destination signaling point code in the second signaling network according to the mapping relation;
the step of forwarding the message in the second signaling network comprises: forwarding the message in the second signaling network when there is a signaling point where the signaling point code is the destination signaling point code in the second signaling network and a state of the signaling point is office direction available.

4. The method according to claim 3, further comprising:
the signaling transfer point, when judging that there is the signaling point where the signaling point code is the destination signaling point code in the second signaling network and judging that the state of the signaling point is an office direction unavailable state, returning an office direction unavailable message to the first signaling network; when judging that the state of the signaling point is a congestion state, returning a signaling point congestion message to the first signaling network.

5. The method according to claim 1, wherein,
the mapping relation comprises a corresponding relation of network types of the first signaling network and the second signaling network;
the step of converting the message into the message in the second signaling network according to the mapping relation comprises: the signaling transfer point, after receiving a signaling point congestion message carrying the destination signaling point code sent by the first signaling network and when judging that no adjacent office where the signaling point code is the destination signaling point code is configured in the first signaling network, converting the destination signaling point code in the first signaling network into the destination signaling point code in the second signaling network according to the mapping relation.

6. The method according to claim 1, wherein,
the mapping relation comprises a corresponding relation of network types of the first signaling network and the second signaling network and a corresponding relation of signaling point codes; the step of converting the message into the message in the second signaling network according to the mapping relation comprises: converting the destination signaling point code in the first signaling network in the message into a second destination signaling point code in the second signaling network according to the mapping relation.

7. A system for implementing message interaction across network types, comprising a signaling transfer point belonging to more than one signaling network at the same time, the signaling transfer point comprising a mapping relation configuring unit and a message forwarding unit; wherein,
the mapping relation configuring unit is configured to set a mapping relation between different signaling networks on the signaling transfer point according to an interaction requirement of said different signaling networks;
the message forwarding unit is configured to: after receiving a message indicating a destination signaling point code sent by a first signaling network and when judging that there is no signaling point where a signaling point code is the destination signaling point code in the first signaling network, convert the message into a message in a second signaling network according to the mapping relation, and when judging that a destination signaling point of the converted message is available in the second signaling network, forward the message in the second signaling network.

8. The system according to claim 7, wherein,
the mapping relation stored by the mapping relation configuring unit comprises a corresponding relation of net work types of the first signaling network and the second signaling network;
the message forwarding snit is configured to: after receiving the message indicating the destination signaling point code sent by the first signaling network and when judging that there is no signaling point where the signaling point code is the destination signaling point code in the first signaling network, convert the destination signaling point code in the first signaling network into the destination signaling point code in the second signaling network according to the mapping relation, and forward the message in the second signaling network when there is a signaling point where the signaling point code is the destination signaling point code in the second signaling network and the signaling point is available in the second signaling network.

9. The system according to claim 7, wherein,
the mapping relation stored by the mapping relation configuring unit comprises a corresponding relation of network types of the first signaling network and the second signaling network;
the message forwarding unit is configured to: after receiving a destination state audit message carrying the destination signaling point code sent by the first signaling network and when judging that no adjacent office where the signaling point code is the destination signaling point code is configured in the first signaling network, convert the destination signaling point code in the first signaling network into the destination signaling point code in the second signaling network according to the mapping relation, and forward the message in the second signaling network when there is a signaling point where the signaling point code is the destination signaling point code in the second signaling network and a state of the signaling point is office direction available.

10. The system according to claim 9, wherein,
the message forwarding unit is further configured to: when judging that there is the signaling point where the signaling point code is the destination signaling point code in the second signaling network and judging that the state of the signaling point is an office direction unavailable state, return an office direction unavailable message to the first signaling network; when judging that the state of the signaling point is a congestion state, return a signaling point congestion message to the first signaling network.

11. The system according to claim 7, wherein,
the mapping relation stored by the mapping relation configuring unit comprises a corresponding relation of network types of the first signaling network and the second signaling network;
the message forwarding unit is configured to convert the message into the message in the second signaling network according to the mapping relation by a following way: after receiving a signaling point congestion message carrying the destination signaling point code sent by the first signaling network and when judging that no adjacent office where the signaling point code is the destination signaling point code is configured in the first signaling network, converting the destination signaling point code in the first signaling network into the destination signaling point code in the second signaling network according to the mapping relation.

12. The system according to claim 7, wherein,
the mapping relation stored by the mapping relation configuring unit comprises a corresponding relation of network types of the first signaling network and the second signaling network and a corresponding relation of signaling point codes; and
the message forwarding unit is configured to convert the message into the message in the second signaling network according to the mapping relation by a following way: after receiving the message indicating the destination signaling point code sent by the first signaling network and when judging that there is no signaling point where the signaling point code is the destination signaling point code in the first signaling network, converting the destination signaling point code in the first signaling network in the message into a second destination signaling point code in the second signaling network according to the mapping relation.

13. The system according to claim 11, wherein,
the signaling transfer point further comprises a state management unit, and the state management unit is configured to maintain states of the signaling transfer points between different signaling networks.

14. The system according to claim 11, wherein,
the state management unit is configured to: when receiving an office direction available message, update a state of the signaling transfer point as an office direction available state; when receiving an office direction unavailable message, update the state of the signaling transfer point as art office direction unavailable state; when receiving the signaling point congestion message, update the state of the signaling transfer point as a congestion state.

15. A signaling transfer point, characterized in that the signaling transfer point belongs to more than one signaling network at the same time, and the signaling transfer point comprises:
a mapping relation configuring unit, configured to set a mapping relation between different signaling networks on the signaling transfer point according to an interaction requirement of said different signaling networks; and
a message forwarding unit, configured to: after receiving a message indicating a destination signaling point code sent by a first signaling network and when judging that there is no signaling point where a signaling point code is the destination signaling point code in the first signaling network, convert the message into a message in a second signaling network according to the mapping relation, and when judging that a destination signaling point of the converted message is available in the second signaling network, forward the message in the second signaling network.

16. The signaling transfer point according to claim 15, wherein,
the mapping relation comprises a corresponding relation of network types of the first signaling network and the second signaling network; and
the message forwarding unit is configured to convert the message into the message in the second signaling network according to the mapping relation by a following way: converting the destination signaling point code in the first signaling network into the destination signaling point code in the second signaling network according to the mapping relation.

17. The signaling transfer point according to claim 15, wherein,
the mapping relation comprises a corresponding relation of network types of the first signaling network and the second signaling network and a corresponding relation of signaling point codes; and
the message forwarding unit is configured to convert the message into the message in the second signaling network according to the mapping relation by a following way: converting the destination signaling point code in the first signaling network in the message into a second destination signaling point code in the second signaling network according to the mapping relation.

18. The signaling transfer point according to claim 16, wherein,
the message forwarding unit is configured to: after receiving a destination state audit message carrying the destination signaling point code sent by the first signaling network and when judging that no adjacent office where the signaling point code is the destination signaling point code is configured in the first signaling network, convert the destination signaling point code in the first signaling network into the destination signaling point code in the second signaling network according to the mapping relation, and forward the message in the second signaling network when there is a signaling point where the signaling point code is the destination signaling point code in the second signaling network and a state of the signaling point is office direction available.

19. The signaling transfer point according to claim 18, wherein,
the message forwarding unit is further configured to: when judging that there is the signaling point where the signaling point code is the destination signaling point code in the second signaling network and judging that the state of the signaling point is an office direction unavailable state, return an office direction unavailable message to the first signaling network; when judging that the state of the signaling point is a congestion state, return a signaling point congestion message to the first signaling network.

20. The signaling transfer point according to claim 19, further comprising:
a state management unit, configured to maintain states of the signaling transfer points between different signaling networks.
